(19) United States
(12) Patent Application Publication
(10) Pub. No.: US 2013/0001475 A1
(43) Pub. Date: Jan. 3, 2013

(54) MATERIAL COMPOSITION, METHOD OF PRODUCING THE COMPOSITION, AND OXIDATION-PROTECTED MANUFACTURE

(75) Inventors: MARTIN CHRIST, AUGSBURG (DE); SANDRA KÖHLER, BAAR (DE); FLORIAN GOJNY, KELKHEIM (DE); RAINER SCHMITT, AUGSBURG (DE); OSWIN ÖTTINGER, MEITINGEN (DE)

(73) Assignee: SGL CARBON SE, WIESBADEN (DE)

(21) Appl. No.: 13/616,232

(22) Filed: Sep. 14, 2012

Related U.S. Application Data
(63) Continuation of application No. PCT/EP2011/054021, filed on Mar. 17, 2011.

(30) Foreign Application Priority Data
Mar. 17, 2010 (DE) 102010002989.0-17

(51) Int. Cl. C09D 1/00; B32B 37/24; C09D 171/10; F16J 15/06; C09J 1/00; C09J 171/10; H01B 1/00; C04B 35/622; C08K 5/05

(52) U.S. Cl. 252/500; 264/239; 156/242; 106/286.4; 106/286.8; 524/391; 277/628; 277/608

(57) ABSTRACT

A material composition is formed with a carrier component and an additive component. The additive component has one or more ceramic additives. The carrier component and the additive component are present in a ratio by volume in the range from approximately 1:9 to approximately 7:3, preferably in the range from approximately 1:4 to approximately 2:1. More particularly, they are present in a ratio of approximately 1:1. The material composition may be formed as a foil or as a liquid, viscous, paste or gel material. The material composition may be used, inter alia, as oxidation protection and as a sealing element.

### CROSS-REFERENCE TO RELATED APPLICATION

This application is a continuation, under 35 U.S.C. §120, of copending international application No. PCT/EP2011/054021, filed Mar. 17, 2011, which designated the United States; this application also claims the priority, under 35 U.S.C. §119, of German patent application No. DE 10 2010 002 989.0, filed Mar. 17, 2010; the prior applications are herewith incorporated by reference in their entirety.

### BACKGROUND OF THE INVENTION

### Field of the Invention

The present invention relates to a material composition, in particular to a composition for oxidation protection and/or sealing, to a process for its production and also to implementations of the material composition. In particular, the present invention also relates to a high temperature oxidation protection foil.

When being produced, and also when in use and operating, the operating parameters of many utility items and much equipment, for example the temperature parameter, cover a wide range of values. Depending on the application, a workpiece, tool or a utility item may be subjected to temperatures from ambient temperature, or even well below, to several hundred or even more than 1000° C. Within the various temperature regions, under certain circumstances the mechanical and/or thermal loads on the individual material components, including the surfaces or boundaries, are frequently very different.

Under such circumstances with thermally activated surfaces or boundaries, chemical changes may occur, in particular oxidation processes, which also change the properties of the base materials at their surfaces or boundaries. As a result, oxidation may also have a deleterious effect on, say, the electrical resistance—this is, for example, highly relevant as regards electrodes or the like—and/or on the integrity of the material—this is, for example, highly relevant having regard to seals.

In order to avoid such wear situations or at least to mitigate them, inherent or additional layers of material are often applied to the surfaces or boundaries or parts of regions in order, for example, to act as protective layers or to have other functions, for example to act as seals. Such inherent or additional material layers should have suitable properties over the whole range of the operating parameters, in particular over the whole temperature range, and the base surface or boundary—compared with a situation without inherent or additional layers—should be conserved and/or stabilized.

Thus, with an oxidation layer that is applied to a boundary or surface, it is desirable for the application per se, which is often carried out in the ambient temperature range, is not deleteriously affected bur rather should be improved by the flexibility of the material of the additional layer. This means that the material should be as cohesive as possible at ambient temperature and also should have a certain mechanical flexibility, for example in the form of pliability. On the other hand, in the high temperature region, the protective function and the mechanical continuity or cohesion of the base material should not change substantially, since otherwise the function of the additional layer could be compromised.

Many other properties can also be taken into consideration that have to persist over the entire temperature range or over a large portion thereof, for example electrical conductivity, which should preferably be present at ambient temperature, but might not be required at much higher temperatures under certain circumstances.

When considering seals that are supposed to be provided in connection with a material transition, for example between two flanges or the like, at ambient temperature, for example during assembly, continuity or cohesion of the material should again coexist with a certain mechanical flexibility. In addition, in order to function as a seal, leakage must be as small as possible over the entire operational temperature range; this is often associated with the material continuity or cohesion of the base material composition of the seal.

In addition to the problems described above in connection with possible oxidation of a base material in a workpiece or tool, oxidation processes are also problematic when using material compositions to modify the surfaces or boundaries of workpieces or tools, since oxidation can also affect the properties of known material compositions in a deleterious manner.

In addition, known material compositions, such as, for example, foils, can only be produced using comparatively sophisticated processes and equipment that use large quantities of energy.

### SUMMARY OF THE INVENTION

It is accordingly an object of the invention to provide a novel material composition which overcome the above-mentioned disadvantages of the heretofore-known devices and methods of this general type and which provides for a material composition with a material continuity or cohesion that remains high over a broad range of temperatures, especially in the high temperature range above 700° C. and that can be produced using comparatively simple processes and equipment and with a comparatively low energy requirement.

With the foregoing and other objects in view there is provided, in accordance with the invention, a material composition, comprising:

a carrier component; and

an additive component having one or more ceramic additives;

wherein a ratio by volume of the carrier component to the additive component lies in a range from substantially 1:9 to substantially 7:3, preferably in the range from approximately 1:4 to approximately 2:1, and more preferably 1:1.

In other words, the objects of the invention are achieved with a material composition—which in particular is suitable for or as protection against oxidation and/or for or as a seal—with a carrier component and with an additive component, wherein the additive component contains one or more ceramic additives and wherein the ratio by volume of the carrier component to the additive component is in the range from approximately 1:9 to approximately 7:3.

A central concept of the present invention is thus to ensure that the material composition has a specific ratio by volume of the carrier component with respect to the additive component such that the material continuity, the material cohesion and the material resistance, i.e. the mechanical integrity of the entire structure, holds over a broad temperature range such that when the material is used, the properties inherent to the material integrity of the material composition itself, and also when it is used in a material system in which the material composition is used, are also stabilized over a broad temperature range or are even maintained.

The thus stabilized properties may concern the dimensional stability, microstability, for example as regards gas impermeability or the like, or the electrical conductivity of the system the development of which is dependent upon the material composition.

The material composition produced by means of the invention has a material continuity or cohesion that is maintained over a broad temperature range, especially in the high temperature range above 700° C. The material composition produced by means of the invention can be manufactured using a comparatively simple process and equipment and with a comparatively lower energy requirement, in particular when it is produced as a ready-made foil or in the form of a coating or the like.

Foils of the material compositions cannot in fact be produced using anything other than the process of the invention.

The carrier component and the additive component may be provided in a ratio by volume in the range from approximately 1:4 to approximately 2:1, preferably in the region of approximately 1:1. The particularly preferred specifications cited for the range for the ratio by volume of the carrier component to the additive component means that particularly suitable material compositions of the present invention can be characterized, whereby the properties of the material composition alone or of systems using the material composition of the invention can be stabilized particularly well.

The material composition of the invention can be formed as a graphite foil provided with or filled with one or more ceramic additives.

The material composition of the invention may also be formed as a resin-based material provided with one or more ceramic additives, in particular and again as a foil or as a liquid, viscous, paste-like or gel-like material and/or with one or more functional additives.

The at least one ceramic additive may be constituted by or have a high temperature resistant material, a glass-forming material and/or a material that oxidizes and thus sinters—in particular at temperatures over approximately 700° C. Simply combining these features provides the material composition with particularly advantageous properties as regards stabilization and material coherence, because in the high temperature range, oxidation of the ceramic additive results in stabilization and protection because sintering occurs.

The at least one ceramic additive may be constituted by or comprise a material from the group formed by TiB₂, TiO₂, Si, SiC, Si₃N₄, BN, B₄C, CaB₆, FeB, Si₃N₄, Zr(HPO₄)₂, Al₂O₃, AlB₂, AlB₁₂, SiB₆, PB, ZnO.B₂O₃, zinc phosphate, zinc borates and combinations thereof. These cited materials in particular and their combinations constitute particularly reliable bases for the stabilizing effect of the material composition of the invention.

In particular, the following pairs may be provided as first and second additives of the additive component, namely B₄C respectively SiC, B₄C respectively Zr(HPO₄)₂, B₄C respectively TiO₂, TiB₂ respectively Si, or TiO₂ respectively Si, namely in accordance with Table A below:

TABLE A
pairs of first and second additives

| # | Additive 1 | Additive 2 |
|---|---|---|
| 1 | B₄C | SiC |
| 2 | B₄C | Zr(HPO₄)₂ |
| 3 | B₄C | TiO₂ |
| 4 | TiB₂ | Si |
| 5 | TiO₂ | Si |

The examples cited here for pairs of first and second additives for the additive component have been shown to be particularly suitable embodiments as regards stabilization of the properties of the material composition of the invention per se, and also with it in connection with systems to be stabilized.

The carrier component may comprise or be formed from a graphite material, an expanded graphite insertion compound employing H₂SO₄ (SA), an expanded graphite insertion compound employing HNO₃ (NA) and/or mixtures thereof (NSA), one or more fibrous materials based on carbon or combinations thereof, wherein it is in particular in the expanded and/or powdered form and/or wherein one or more functional additives are provided, for example formed with or formed from a synthetic graphite or one or more types of carbon black.

The materials cited here provide the possibility of foil formation, graphite foil formation and/or the formation of carbon felt and/or graphite felt by bonding the carrier component with the respective additive component, wherein an inherent electrical conductivity is ensured because it is carbon-based.

Materials, in particular foils, based on or having expanded graphite are particularly advantageous and thus preferred. In this regard, a graphite foil can, for example, be produced, in which (A) initially, a graphite material is prepared; (B) then a so-called graphite insertion or intercalation compound is produced; (C) which is thermally decomposed and expanded—for example by shock heating at temperatures of approximately 1000° C.—and (D) the expanded material is compacted as a carrier component after mixing with one or more additives for the additive component—and, if appropriate, functional additives—by compression, to shape the material composition into a foil.

The carrier component may be formed from a resin material, in particular from a phenolic resin material and/or with or from one or more thermoset or thermoplastic polymers or the like. The use of resins, in particular in the liquid, viscous, paste-like or gel-like form means that a suitable material composition can be provided for use as a coating or a form-following covering layer, and thus can be used in a particularly flexible manner.

It is also possible to use and/or transfer resins in the form of a foil, wherein the additive component and its components are introduced by compression and/or admixing into the existing resin-based foils.

Particularly advantageously, for particular applications, material compositions can be used that are in the form of a foil and/or a felt, in particular at ambient temperature. Foils and felts are particularly easy to handle since they are essentially dimensionally stable, possess mechanical flexibility and elasticity and can be cut to length as required.

Furthermore, for other specific uses, material compositions that are in the form of a liquid, viscous, paste-like or gel-like material may be advantageous, particularly at ambient temperature. This form for the material compositions can be given any shape, for example by painting or the like.

Advantageously, particularly at ambient temperature, the material composition of the invention is mechanically cohesive, mechanically flexible, mechanically elastic and/or electrically conductive. These properties can be obtained individually or in any combination with each other by the composition of the individual carrier components and additive components in order to be adapted to the respective applications in a particularly flexible art and manner. Aspects of plastic deformability may also be taken into consideration.

The material composition of the invention may be or be constructed such that at a temperature of more than approximately 700° C. it is or remains mechanically cohesive. Mechanical continuity or cohesion or mechanical integrity in the high temperature range are particularly important, because in this case, the prior art cannot guarantee mechanical integrity and thus the function of the base material composition beyond 700° C.

The additive components may have one or more functional additives with or formed from a graphite material, a synthetic graphite, a natural graphite, one or more types of carbon black, one or more fibrous materials based on carbon or combinations thereof, wherein they are in particular in the expanded and/or powdered form.

Alternatively or in addition, the additive components may have one or more functional additives with or formed from a metallic material, preferably with copper, in particular in the powdered form.

Modifying the additive components by functional additives can also provide the material composition with more properties. It is also possible to envisage adding metallic materials, for example in the form of dust, preferably copper dust or the like. This may, for example, act to modulate the electrical conductivity in a resin as the base carrier component.

The carrier components and the additive components may be or may essentially be provided as a mixture of materials. This also encompasses solutions, suspensions, emulsions, solid mixtures and the like. Being provided as a mixture of substances guarantees a particularly intimate contact and particularly intimate entangling of the carrier components with the additive components, and thus a particularly homogeneous material structure for the material composition.

In a further aspect, the present invention provides an appropriate process for the production of the material composition of the invention.

In a process of the invention for the production of a material composition, the carrier components and the additive components are mixed in an appropriate ratio by volume and compressed to a foil. This procedure transforms the material composition of the invention mixed in the appropriate ratio by volume of the mixed carrier components and the additive components into a foil material that can then be used.

In this regard, prior to compressing with the additive component, the carrier components may already be present as a foil. This means that a preformed foil can be enhanced by appropriate further processing in the context of the material composition of the invention by adding the additive component and retaining the foil structure.

Expanded graphite material is particularly preferred as the carrier component or as a part thereof.

In a further embodiment of the production process of the invention, (a) the carrier components may be provided as or already formed as a liquid, viscous, paste-like or gel-like resin prior to compressing with the additive component and the additive component is added in the appropriate ratio by volume; (b) the resulting liquid, viscous, paste-like or gel-like mixture may be cast into a foil and if appropriate hardened and/or compressed; and (c) in particular, the resulting foil may be laminated, for example onto a workpiece or the like.

Alternatively, in a process for the production of a material composition, the carrier component may be provided as a liquid, viscous, paste-like or gel-like material and the additive component may be provided as bulk material, as powder, or as a liquid, viscous, paste-like or gel-like material. In this regard, the carrier component and the additive component are mixed together in the appropriate ratio by volume and the resulting mixture is either made into the form of a liquid, viscous, paste-like or gel-like material or into the form of a foil of the material composition by means of a further processing step. Instead of a foil, the material composition produced is constituted as a material that is easier to shape, wherein here as an end result a liquid, viscous, paste-like or gel-like end product with the material composition of the invention is produced that can be used subsequently.

It is also possible for the carrier component and/or an intermediate form of the material composition of the invention to be initially in the form of a liquid, viscous, paste-like or gel-like material and then to be transformed into a foil by means of an intermediate or further processing procedure, for example by casting, possibly with subsequent hardening.

Further aspects of the present invention are constituted by various uses of the material compositions of the invention.

It is possible to use the material composition of the invention as oxidation protection—in particular a graphite or carbon-based or graphite- or carbon-reinforced body or workpiece. Because the properties of the material composition of the invention can be modulated, it is particularly suitable for use for oxidation protection, for example to improve an essentially solid body, workpiece or tool, in particular based on graphite or carbon and/or with a graphite or carbon reinforcement.

The material composition of the invention may be provided as a coating on the surface or on a portion of the surface of the body or workpiece or as a material admixture on or in the surface or on or in a portion of the surface of the body or workpiece.

The body or the workpiece on which the material composition of the invention is used may be a heat shielding element, a thermal tile, an electrode, an arc electrode or a tool or the like.

Furthermore, the material composition of the invention may be used as a seal between two workpieces, in particular on a flange or the like, preferably as a flat seal, ring seal or band seal. Because the properties of the material composition can be modulated and thus the leakage can be set to be low, the material composition of the invention can even be used as a seal material when constituted appropriately.

As already indicated above with respect to the general aspects, the central concept of the present invention lies in providing a carrier component and an additive component (a) as the starting materials for a material composition or (b) in the final configuration of the material composition, each in a specific ratio by volume in accordance with the invention.

This means that the material continuity, the material cohesion and thus the material integrity of the material composition is retained over a particularly broad range of operating temperatures.

In particular, this means that at low temperatures, for example in the ambient temperature range, the material composition is particularly easy to handle in its respectively aggregated condition. On the other hand, even at high operating temperatures, the material integrity is not compromised and thus the cohesion of the material composition is retained, so that the mechanical properties, which are based on the material integrity, are retained. This means that the respective product obtained does not decompose and/or does not form noteworthy holes at high temperatures.

While material integrity is obtained at low temperatures essentially because of the carrier components, in the high temperature range, in particular beyond 700° C., the material integrity may be obtained by means of the additive component, for example by it forming a glass or by sintering. Thus, if the carrier component breaks down at high temperatures because, for example, it consists of graphite, for example by means of oxidation processes, the properties of the components of the additive component mean that the material integrity of the material composition is maintained overall, namely in particular when the components of the additive component are ceramic and glass-forming components.

The terms “carrier component” and “additive component” as used in the context of the present invention should be construed in a completely general manner. The term “carrier component” thus on the one hand actually means carbon materials or graphite materials, but also resin materials or the like. What is important is that the carrier component provides the material integrity in the low temperature range, and possibly also the mechanical flexibility and/or elasticity, for example as regards the pliability of a foil or the like. The additive component then for its part provides the material integrity in the high temperature range. Furthermore, by adding so-called functional additives, the spectrum of properties of the material composition can be broadened, for example by adding functional additives that influence the electrical conductivity. Clearly, appropriate functional additives may also be added to the carrier component, for example when the material acting as the binder has an insufficient intrinsic electrical conductivity.

Other features which are considered as characteristic for the invention are set forth in the appended claims.

Although the invention is illustrated and described herein as embodied in a material composition, production thereof and use of same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A-C illustrate the use of the material composition of the invention in a first embodiment in which the material composition is applied to the surface of a workpiece;

FIGS. 2A-C show another use of the material composition of the invention in which it is introduced as a type of impregnation into the surface region of a workpiece to be processed;

FIGS. 3A-4C show, in a diagrammatic and part sectional form, another use of the material composition of the invention, in this case in the processing of a cylindrical body, for example an electrode or the like;

FIGS. 5A-C show, in a diagrammatic and part sectional form, another way of using the material composition of the invention, wherein in this case a plurality of layers with the material composition of the invention are applied to the surface of a body;

FIGS. 6A-C show, in a diagrammatic and part sectional form, the use of the material composition of the invention as a seal between two parts;

FIG. 7 is a block diagram illustrating a production process and a way of using the material composition of the invention;

FIG. 8 is a block diagram illustrating another production process and another way of using the material composition of the invention; and

FIG. 9 is a block diagram illustrating yet another production process and another way of using the material composition of the invention

### DETAILED DESCRIPTION OF THE INVENTION

The following is a description of embodiments of the present invention. All of the embodiments of the invention and also their technical features and properties may be in isolation or combined in any combination without limitation.

Structurally and/or functionally identical or similar features or elements, or features or elements having the same effect will be given the same reference numerals in the figures. A detailed description of these features or elements will not be repeated in each case.

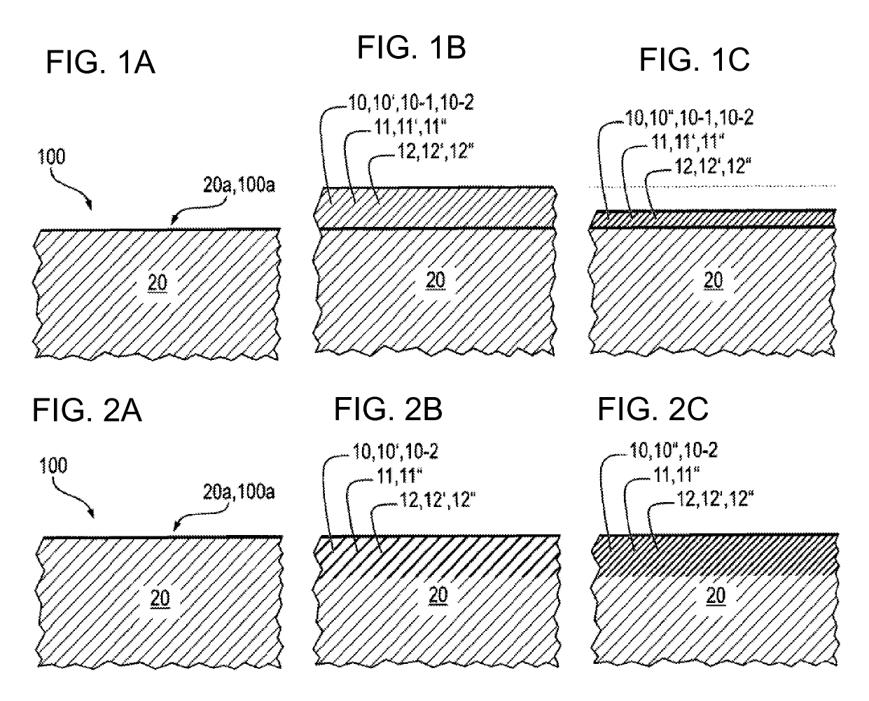

Referring now to the figures of the drawing in detail and first, particularly, to FIGS. 1A to 1C thereof, there is shown, in a diagrammatic and part sectional form, a first application possibility of an embodiment of the material composition of the invention.

In this regard, a single layer of the material composition of the invention 10 is applied to the surface 20a of a material 20 to be processed, for example a workpiece 100 or a tool 100 in the arrangement shown in FIG. 1A—see FIG. 1B. The material composition 10 of the invention can be pulled over as a foil 10-1 or applied as a liquid, viscous, paste-like or gel-like coating 10-2. This is carried out at ambient temperature (here, also referred to as standard temperature), for example, and the material composition of the invention 10 thus attains a specific first or starting configuration 10′ and in accordance with the invention contains the carrier component 11—for example with graphite 11′ or resin 11″—and the additive component 12 with one or more additives 12′, 12″.

An intermediate or further processing step, for example a heating step, may then follow. This can either be based on a higher operating temperature or an explicit high temperature processing step.

It is possible, see FIG. 1C, for the material composition 10 of the invention to take up a second configuration 10″ in the high temperature region or during or after the high temperature step. This second configuration 10″ can also be accompanied by compaction and thus a reduction in volume of the material composition of the invention, as can clearly be seen in FIG. 1C. This is not obligatory, however. It is also possible for the material composition 10 of the invention to retain the configuration 10′ over the whole temperature range.

In practice, the material composition 10 of the invention may be formed by a foil 10-1 formed from a mixture of graphite 11′ and ceramic additives 12′, 12″. At standard, i.e., ambient temperature, in this case the foil 10-1 produced contains both the graphite as a carrier component 11 and also the ceramic components 12′, 12″ as the additive component 12. At very high temperatures, some or all of the components of the material composition 10 of the invention may oxidize. As an example, a substantial proportion of the graphite 11′ in the configuration 10″ of the material composition 10 of the invention may disappear, while the ceramic components 12′, 12″ have organized themselves into the second configuration 10″ of the material composition of the invention, for example transformed into a glass-like state, accompanied by a smaller volume, without loss of material integrity, material continuity or cohesion.

In the embodiment of FIGS. 2A to 2C, comparable processes to those in FIGS. 1A to 1C occur, but the material composition 10 of the invention is not applied to the surface 20a of the base body 20, but is introduced in the form of a type of impregnation into the surface 20a of the material 20 of the workpiece 100, as can be seen by the difference between FIG. 2A and FIG. 2B. Thus, in FIG. 2B, the body 100 has an improved form with surface impregnation by this embodiment of the material composition 10 of the invention.

Turning now to FIG. 2C, this shows that after a high heat treatment, whether explicit or implicit on the basis of increased operating temperatures when using the processed body 20, a transformation occurs in the region of the impregnated surface 20a so that a second configuration 10″ is produced that is different from the configuration 10′ shown in FIG. 2B.

It should be noted that the difference between the first and second configurations 10′ or 10″ is not obligatory. In principle, after completion and application or introduction into the material 20 of the body 100, the material composition 10 of the invention may in fact remain unchanged over the entire temperature range.

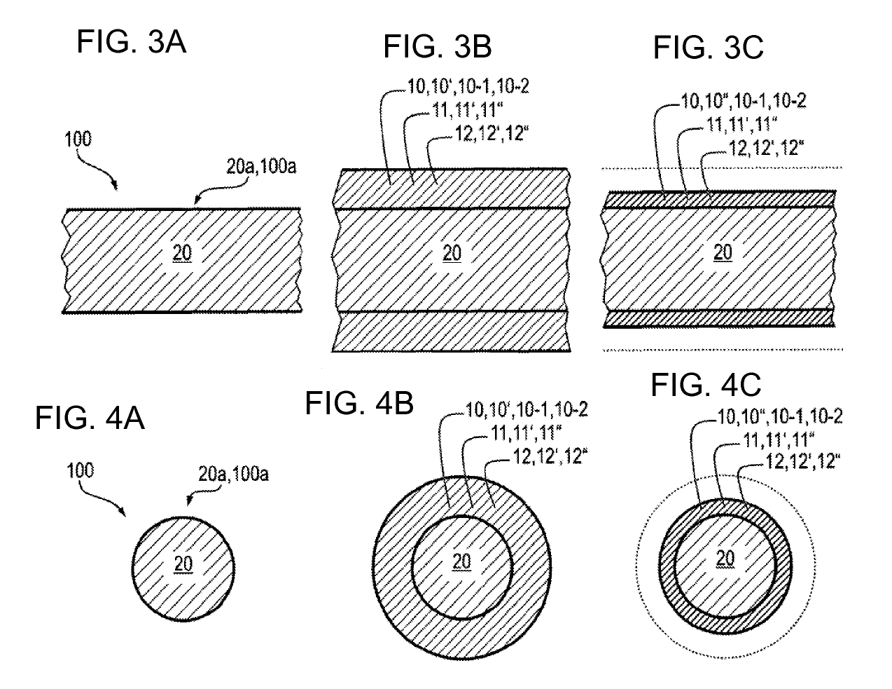

FIGS. 3A to 4C show, in analogous manner to FIGS. 1A to 1C, the use of an embodiment of the material composition 10 of the invention in a cylindrical body 100, for example an electrode, preferably an arc electrode or the like. In this regard, FIGS. 3A to 3C show a cylindrical shape in a lateral cross-sectional view, whereas FIGS. 4A to 4C show the cylindrical body 100 or the electrode 100 viewed in the direction of the cylinder axis.

Here again, three phases of the production process are shown, namely in FIGS. 3A and 4A the body 100 in its initial form, in FIGS. 3B and 4B the surface 20a, 100a of the body 100 formed from a material 20 coated with an embodiment of the material composition 10 of the invention, in its first or low temperature configuration 10′, and in FIGS. 3C and 4C in the second or high temperature configuration 10″, wherein again, it is assumed that compaction occurs with corresponding volume shrinkage, retaining material integrity.

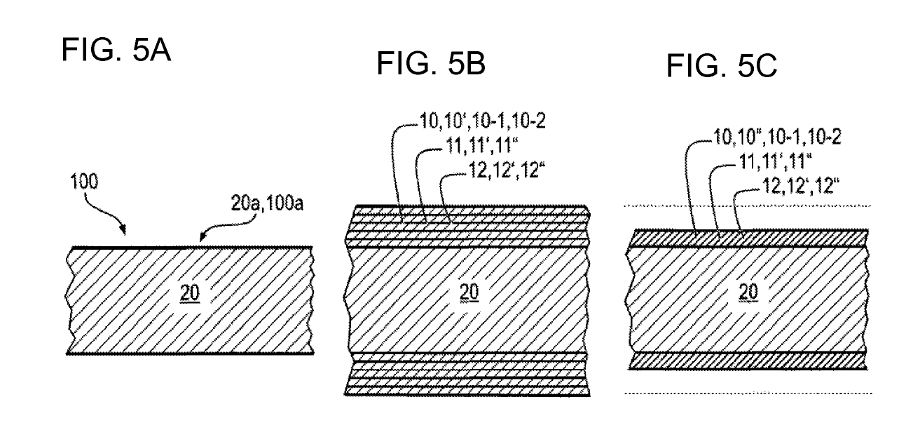

FIGS. 5A to 5C show an analogous configuration to FIGS. 1A to 1C, but in this case the embodiment of the material composition of the invention 10 is applied to the surface 20a, 100a of the base material 20 or body 100 in a plurality of layers, as can be seen in FIG. 5B. In transforming from the first or low temperature configuration 10′ shown in FIG. 5B to the second or high temperature configuration 10″ shown in FIG. 5C, the layered structure of the material composition 10 of the invention essentially breaks down, producing a compacted arrangement 10″ with loss of the layering of the material composition 10 of the invention on the surface 20a, 100a of the material 20 of the body 100.

The multilayer structure of the material composition 10 of the invention of FIG. 5B may, for example, be obtained by winding several layers of a foil 10-1. It is also possible to apply several coats of a paint 10-2, possibly with interposed drying steps.

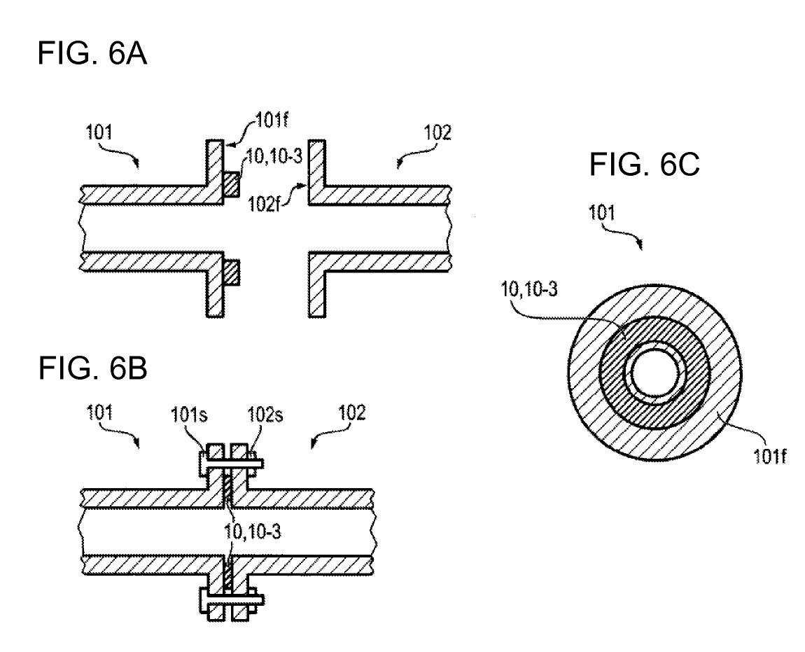

FIGS. 6A to 6C show how the material composition 10 of the invention can be applied as a seal 10-3 between first and second tubular bodies 101 and 102.

In FIG. 6A, the two tubular pieces 101, 102 or bodies 101, 102 are separate and spaced from each other and on each respective end form matching first and second flanges 101f and 102f. On the first flange 101f of the first body 101, i.e. the first tube 101, is a ring-shaped seal 10-3 based on the material composition 10 of the invention, as shown in the top view shown in FIG. 20C. On going from FIG. 6A to FIG. 6B, the first and second tubular parts 101 and 102 are connected together with their end faces together, i.e. at the first and second flanges 101f and 102f with the seal 10-3 formed from the material composition 10 of the invention, using first and second screw elements 101s and 102s.

Because of the superb material properties, namely more stable material integrity over a broader temperature range, the material composition 10 of the invention is suitable for sealing the transition between the first and second tubes 101 and 102 in the region of the first and second flanges 101f and 102f; leakage rates are substantially reduced compared with known gaskets or the like.

These and other aspects will now be illustrated further by the following observations and various examples:

### Example 1

This describes a type of production and tests to investigate the properties of a material composition 10 of the invention.

Commercially available graphite hydrogen sulfate 11′ (SS3, Sumikin Chemical Co Ltd, Tokyo, Japan) was shock heated to 1000° C. to obtain an expanded graphite. 5.0 g of the expanded material obtained was mixed together with two additives 12′, 12″, namely 1.3 g of B₄C powder (ESK Ceramics GmbH & Co. KG, Kempten, Germany) with a d₅₀ of 15 μm and with 3.7 g of SiC powder (ESK-SIC GmbH, Frechen, Germany) with a d₅₀ of 6 μm in a tumbler mixer and compressed into a disk-shaped foil 10-1 with a thickness of 1 mm and a diameter of 90 mm. The foil obtained was materially cohesive and mechanically flexible.

For further examination, this foil 10-1 was exposed to air at 1300° C. in a platinum crucible. The loss of weight of the foil was determined at regular intervals. After approximately 3 h, the weight became constant at approximately 6.5 g. After the heat treatment, the foil remained stable, free of holes and brittle.

### Example 2

Graphite foil 10-1 filled with various ceramic powders 12′, 12″ was produced using the process described in Example 1. The d₅₀ of the ceramic additives 12′, 12″ were in the range 5 μm to 50 μm. The compositions of the samples are summarized in Table 1. These samples were weighed, exposed to a stream of air at 700° C. (600 l/h) for 1 hour and then weighed again. After this heat treatment, all of the samples formed stable, hole-free and brittle foils 10-1.

The percentage weight losses are shown in Table 2. A highly oxidation protected, commercially available graphite foil 10-1 with the same dimensions (Sigraflex APX2, SGL Technologies GmbH, Meitingen, Germany), treated in the same manner, was used as the comparative sample. This sample was also free of holes, but flexible, following the heat treatment.

An essential difference between the comparative foil and the material composition of the invention is the very different ratio by volume of the invention between the carrier component and additive component; for the comparative foil it was in the range 99:1, i.e. 99% by volume of the comparative foil was constituted by carrier component, thus producing a loss on ignition of 1% in the tests.

TABLE 1
compositions of foils filled with ceramic powders

| Sample | Expanded material | Additive 1 | Additive 2 |
|---|---|---|---|
| 1 | 5 g | 1.3 g B₄C | 3.7 g SiC |
| 2 | 5 g | 2.2 g TiB₂ | 2.8 g Si |
| 3 | 5 g | 2.5 g TiO₂ | 2.5 g Si |

TABLE 2
loss of weight at 700° C. after 1 hour

| Sample | Reference | 1 | 2 | 3 |
|---|---|---|---|---|
| Weight loss [%] | 8 | 5 | 13 | 52 |

### Example 3

Samples with the compositions indicated in Example 2 were oxidized at 1300° C. in a platinum crucible in air for 1 h. The weight losses are shown in Table 3. All of the foils 10-1 filled with ceramic powders 12′, 12″ were stable, free of holes and brittle after the heat treatment. The non-filled reference sample was completely oxidized.

TABLE 3
loss of weight at 1300° C. after 1 hour

| Sample | Reference | 1 | 2 | 3 |
|---|---|---|---|---|
| Weight loss [%] | 100 | 36 | 15 | 53 |

### Example 4

As an example of an application, the cylindrical surface of a cylinder 100 formed from synthetic graphite with a diameter of 50 mm and a height of 30 mm—this functioned as a model, for example of an electric arc electrode—was wound with 2 layers of 1 mm thick graphite foil 10-1 that had been filled with two additives 12′, 12″, namely TiB₂ and Si, i.e. the composition of sample 2 in Table 1, so that the overall external diameter was 54 mm. The foil was attached to the surface of the cylinder 100 using phenolic resin. The end faces of the cylinder 100 were not covered. The cylinder 100 was oxidized for 3 h at 1300° C. in air. In this manner, the filled graphite foil 10-1 on the cylinder surface was transformed into a ceramic foil or layer 10″. The external diameter of the wound cylinder 100 was unchanged after the heat treatment. Traces of oxidation were observed on the end faces which had not been covered.

A comparative model formed from synthetic graphite in a cylindrical shape with a diameter of 50 mm and a height of 30 mm was also oxidized at 1300° C. for 3 hours in air, with no oxidation protection foil. After the heat treatment, traces of oxidation were observed over the entire sample or cylinder surface; after the heat treatment, the external diameter of the cylinder was 45 mm.

### Example 5

Instead of a foil, the material composition of the invention can also be produced in the form of a material 10-2 with an essentially liquid consistency:

To this end, a mixture of 22 g of TiB₂ powder (d₅₀ 10 μm), 28 g of Si powder (d₅₀ 20 μm) as additives 12′, 12″ and 40 g of graphite powder (d₅₀ 5 μm) as an additional functional additive providing electrical conductivity—this mixture functioned as the additive component 12 within the meaning of the invention and the graphite fraction of the total composition provided electrical conductivity even at low temperatures—were stirred into a solution of 50 g of phenolic resin (SP 227, Hexion Specialty Chemicals, Inc) and 50 g of ethanol, functioning as carrier component 11 within the meaning of the invention. This produced a thin liquid mixture that could be painted that served as the coating 10-2.

This was applied to the cylindrical and end surfaces of a cylinder formed from synthetic graphite (diameter: 50 mm; height: 100 mm) in a layer approximately 0.5 mm thick using a paintbrush and dried at ambient temperature for 24 h. Next, the sample was oxidized at 1300° C. for 1 hour in air. This transformed the coating into a ceramic layer; other indications of oxidation were not observed.

### Example 6

The components providing conductivity do not have to be based on graphite or carbon: Here, 33 g of TiB₂ powder (d₅₀ 10 μm), 42 g of Si powder (d₅₀ 20 μm) and 75 g of copper powder (d₅₀ 10 μm), this powder mixture functioning as the additive component 12 in the context of the invention and this time with the copper fraction of the total composition providing the electrical conductivity even at low temperatures, were stirred into a solution of 50 g of phenolic resin (SP 227, Hexion Specialty Chemicals, Inc) and 50 g of ethanol, functioning as carrier component 11 within the meaning of the invention. Again, a thin liquid mixture that could be painted on that functioned as the coating 10-3 was obtained.

This was applied to the cylindrical and end surfaces of a cylinder formed from synthetic graphite with a diameter of 50 mm and a height of 100 mm in a layer approximately 0.5 mm thick using a paintbrush and dried at ambient temperature for 24 h. Next, the sample was oxidized at 1300° C. for 1 hour in air. This transformed the coating into a ceramic layer; other indications of oxidation were not observed.

### Example 7

Using the process described in Example 1, graphite foils 10-1 were produced filled with various ceramic powders as the additives 12′, 12″. The compositions of the samples are shown in Table 4. The thickness was 1 mm (samples 1 and 2) or 0.5 mm (sample 3). The d₅₀ value for the additives was in the range 5 μm to 200 μm. These samples were weighed, exposed to a stream of air (100 l/h) at 700° C. each time for 1 hour and then weighed again. This heat treatment was then repeated until a total of 10 h was attained. After this heat treatment, all of the samples had formed stable, hole-free and partially flexible foils 10-1.

The percentage weight losses are shown in Table 4. A highly oxidation-protected, commercially available graphite foil with the same dimensions (Sigraflex APX2, SGL Technologies GmbH, Meitingen, Germany) was used as a comparative sample and treated in the same manner. This sample was also free of holes after the heat treatment, but it was flexible.

TABLE 4
compositions of foils filled with ceramic powders

| Sample | Expanded material | Additive 1 | Additive 2 |
|---|---|---|---|
| 1 | 5 g | 1.1 g B₄C | 0.3 g Zr(HPO₄)₂ |
| 2 | 5 g | 1.1 g B₄C | 0.3 g TiO₂ |
| 3 | 2.2 g | 0.9 g B₄C | 0.1 g TiO₂ |

TABLE 5
loss of weight at 700° C. after 10 hours

| Sample | Reference | 1 | 2 |
|---|---|---|---|
| Weight loss [%] | 75 | 27 | 70 |

TABLE 6
loss of weight at 700° C. after 5 hours

| Sample | Reference | 3 |
|---|---|---|
| Weight loss [%] | 72 | 52 |

The foils produced in accordance with Example 6 became brittle on heat treatment, but retained some of their flexibility, so that they could be used as a material for conventional seal applications (for example to seal flanged connections). In this case, it is possible in particular to use them at high temperatures, which until now has been reserved for mica-based materials and their combinations. Compressibility and ability to match to untreated surfaces are also present in the ceramic embodiments even after the heat treatment.

The leakage rate in ml/min from sample 1 and sample 2 was tested in accordance with DIN EN 28090-1 and compared with a commercially available mica seal material (reference). The measured leakage rates are shown in Table 7.

TABLE 7
leakage rates in accordance with DIN
EN 28090-1, compared with reference

| Sample | Leakage rate (ml/min) |
|---|---|
| 1 | 3 |
| 2 | 3 |
| Reference | 800 |

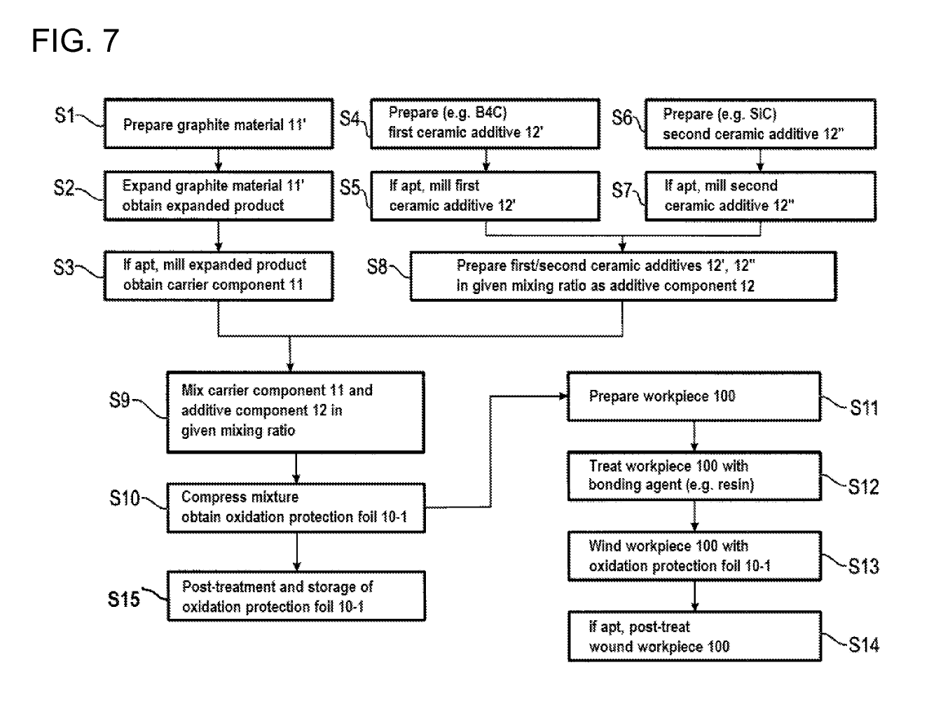

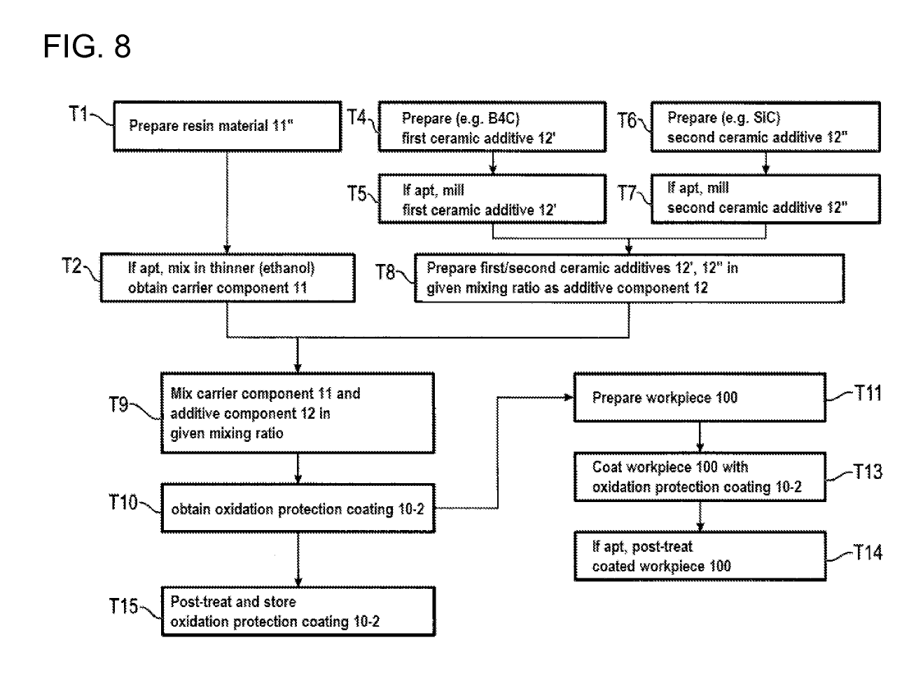

FIGS. 7 and 8 describe, as flow diagrams, two general types of process for the production and application of the material composition 10 of the invention, which also encompasses Examples 1 to 7 described above.

In the process illustrated in FIG. 7, the material composition 10 of the invention is prepared in the form of a foil 10-1 and used as appropriate.

Initially, in step S1, graphite material 11′ is prepared and in step S2, an expansion procedure is carried out. The expanded material obtained is milled if appropriate in step S3 and/or functional additives are added. The result obtained from step S3 is the carrier component 11 of the material composition 10 of the invention.

On the other hand, in steps S4 and S6, first and second additives 12′ or 12″—for example B₄C or SiC—are prepared and in steps S5 or S7 they are each milled and/or supplemented with functional additives if appropriate. In step S8, the intermediate products from steps S4 to S7 are obtained in the appropriate mixing ratio as additive component 12.

In step S9, the carrier component 11 and the additive component 12 are mixed in accordance with the invention in a specific ratio by volume in the range from approximately 1:9 to approximately 7:3 and in step S10 it is compressed to an oxidation protection foil 10-1.

On the one hand, in step S15, a post-treatment or storage step may be carried out on the material composition 10 of the invention.

On the other hand, in connection with the preparation of a workpiece 100, the foil 10-1 may be used in step S11. To this end, the workpiece 100 may initially be treated with an adhesive for the foil 10-1 in step S12, for example with a resin. Next, the workpiece 100 is wound with the foil 10-1 formed from the material composition of the invention, for example in step S13. Next, a post-treatment may be carried out and/or the wound workpiece 100 can be stored.

On the other hand, in the process illustrated in FIG. 8, the material composition 10 of the invention is prepared and if appropriate used in the form of a coating 10-2.

Initially, in step T1, resin material 11″ is prepared and supplemented in step T3 with a solvent, for example ethanol, possibly by admixing. The carrier component 11 of the material composition 10 of the invention is obtained from step T3.

On the other hand, in steps T4 and T6, first and second additives 12′ or 12″—for example β₄C or SiC—are again prepared and in step T5 or T7 may each be milled and/or supplemented with functional additives. In step T8, the intermediate products from steps T4 to T7 are again obtained in an appropriate mixing ratio as additive component 12.

In step T9, again the carrier component 11 and the additive component 12 are mixed in accordance with the invention in a specific ratio by volume in the range from approximately 1:9 to approximately 7:3, and in step T10 an oxidation protection coating 10-2 is prepared.

On the one hand, in step T15 a post treatment step and/or a step for storage of the material composition 10 of the invention are carried out.

On the other hand, in connection with the preparation of a workpiece 100, again the coating 10-2 may be employed in step T11. To this end, the workpiece 100 is initially treated in step T13 with the coating 10-2 by painting it on. In step T14, the coated workpiece 100 is post-treated and/or stored.

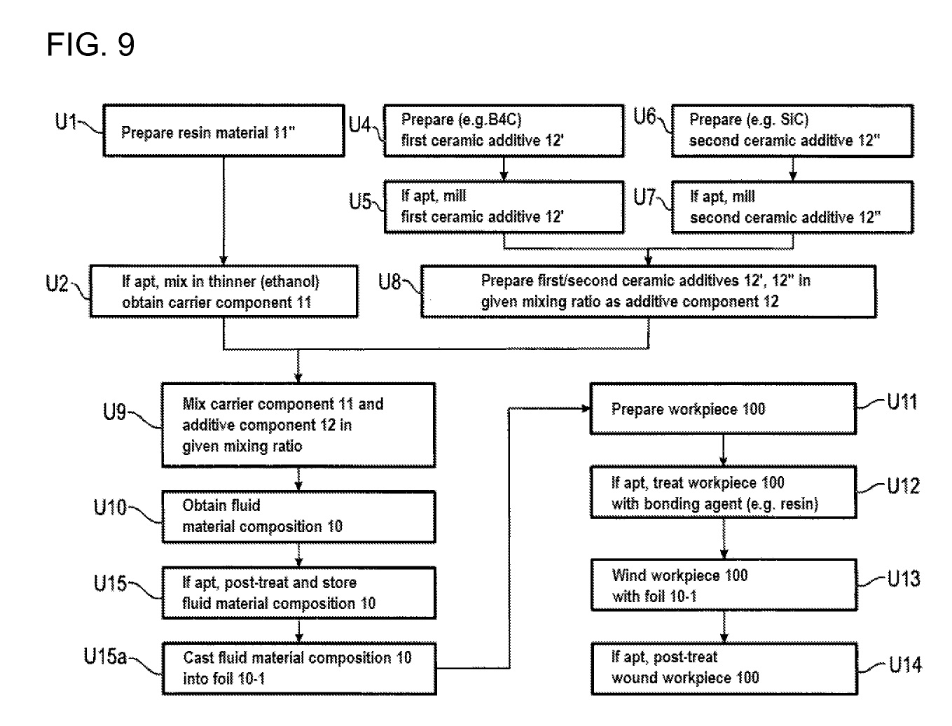

In the process illustrated in FIG. 9 for the production of the material composition 10 of the invention, again it is formed as a foil 10-1, but it is based on a liquid, viscous, paste-like or gel-like resin material 11″ and/or with a liquid, viscous, paste-like or gel-like intermediate product.

Steps U1 to U9 substantially correspond to steps T1 to T9.

In step U10, the material composition 10 of the invention is obtained and prepared as a fluid, i.e. a liquid, viscous, paste-like or gel-like intermediate form.

In step U15, the liquid, viscous, paste-like or gel-like material composition 10 is stored and/or post-treated as appropriate, for example to mature it or to add functional additives.

In step U15a, the liquid, viscous, paste-like or gel-like intermediate form of the material composition 10 of the invention is cast into a foil 10-1 and compressed and/or hardened as appropriate.

In steps U11 and U12, the workpiece 100 is again prepared and it can as appropriate be pre-treated with a bonding agent.

In step U13, the part is wound with the resin-based foil 10-1 and then post-treated as appropriate in step U14.

The following, in order to aid the reader in the perusal of the specification, is a list of reference numerals and identifiers used in the above description and in the figures:
10 material composition of the invention
10′ first configuration or low temperature configuration of the material composition 10 of the invention
10″ second configuration or high temperature configuration of the material composition 10 of the invention
11 carrier component
11′ graphite, carbon,
11″ resin
11-1 foil
11-2 coating
11-3 seal
12 additive component
12′ ceramic additive
12″ ceramic additive
20 material of workpiece or tool 100
20a surface of material 20
100 body, workpiece body, workpiece, tool, graphite or carbon-based body, graphite or carbon-reinforced body
100a surface, surface zone
102 first body, first workpiece body, first workpiece, second tool, first tube, first graphite or carbon-based body, first graphite or carbon-reinforced body
101a surface, surface region
101f flange, first flange
101s screw element, first screw element
102 second body, second workpiece body, second workpiece, second tool, second tube, second graphite or carbon-based body, second graphite or carbon-reinforced body
102a surface, surface region
102f second flange
102s second screw element

1. A material composition, comprising:
a carrier component; and
an additive component, said additive component having one or more ceramic additives;
wherein a ratio by volume of said carrier component to said additive component lies in a range from substantially 1:9 to substantially 7:3.

2. The material composition according to claim 1, wherein the ratio by volume of said carrier component to said additive component is in the range from approximately 1:4 to approximately 2:1.

3. The material composition according to claim 2, wherein the ratio by volume is substantially 1:1.

4. The material composition according to claim 1, configured as oxidation protection or a seal,

5. The material composition according to claim 1, implemented in a graphite foil provided with one or more ceramic additives or implemented in a resin-based material provided with one or more ceramic additives.

6. The material composition according to claim 5, wherein said resin-based material is implemented as a foil or in liquid, viscous, paste, or gel form material and/or with one or more functional additives.

7. The material composition according to claim 1, wherein said at least one ceramic additive consists of, or is composed of, a material selected from the group consisting of a high temperature-resistant material, a glass-forming material, and a material that oxidizes and thereby sinters.

8. The material composition according to claim 7, wherein said at least one ceramic additive is a material that sinters at temperatures above approximately 700° C.

9. The material composition according to claim 1, wherein said at least one ceramic additive consists of, or is composed of, a material selected from the group consisting of TiB₂, TiO₂, Si, SiC, Si₃N₄, BN, B₄C, CaB₆, FeB, Si₃N₄, Zr(HPO₄)₂, Al₂O₃, AlB₂, AlB₁₂, SiB₆, PB, ZnO.B₂O₃, zinc phosphate, zinc borates, and combinations thereof.

10. The material composition according to claim 1, wherein said additive component consists of, or comprises, first and second additives paired as B₄C and SiC, or B₄C and Zr(HPO₄)₂, or B₄C and TiO₂, or TiB₂ and Si, or TiO₂ and Si, in accordance with the following table:

| # | Additive 1 | Additive 2 |
|---|---|---|
| 1 | B₄C | SiC |
| 2 | B₄C | Zr(HPO₄)₂ |
| 3 | B₄C | TiO₂ |
| 4 | TiB₂ | Si |
| 5 | TiO₂ | Si |

11. The material composition according to claim 1, wherein said carrier component consists of, or is composed of, a graphite material, an expanded graphite insertion compound employing H₂SO₄, an expanded graphite insertion compound employing HNO₃ and/or mixtures thereof, one or more fibrous materials based on carbon or combinations thereof.

12. The material composition according to claim 11, wherein said material based on carbon or combinations thereof is present in expanded form and/or pulverized form and/or wherein one or more functional additives are formed of a synthetic graphite or one or more types of carbon black.

13. The material composition according to claim 1, wherein said carrier component consists of, or is composed of, a resin material and/or one or more thermoset or thermoplastic polymers.

14. The material composition according to claim 1, which is present in the form of a foil and/or as a felt at standard temperature.

15. The material composition according to claim 1, configured in liquid, viscous, paste-like, or gel-like material phase at standard temperature.

16. The material composition according to claim 15, configured as a coating.

17. The material composition according to claim 1, which is mechanically cohesive, mechanically flexible, mechanically elastic, and/or electrically conducting at standard temperature.

18. The material composition according to claim 1, which is or remains mechanically cohesive at a temperature of above approximately 700° C.

19. The material composition according to claim 1, wherein said additive component has one or more functional additives constituted by or composed of a graphite material, a synthetic graphite, a natural graphite, one or more types of carbon black, one or more fibrous carbon-based materials or a combination thereof, and/or wherein said additive component has one or more functional additives constituted by or composed of a metallic material.

20. The material composition according to claim 19, wherein said carbon is present in expanded and/or pulverized form, and said metallic material is copper in powdered form.

21. The material composition according to claim 1, wherein said carrier component and said additive component are present as a mixture of the materials.

22. A process for producing the material composition according to claim 1, the method comprising mixing the carrier component and the additive component in an appropriate ratio by volume to form the material composition according to claim 1 and compressing the material into a foil.

23. The process according to claim 22, which comprises:
(a) prior to the compressing step, providing the additive component and the carrier component as a liquid, viscous, paste-like or gel-like resin, and adding the additive component in the appropriate ratio by volume to form a mixture;
(b) casting the resulting liquid, viscous, paste-like or gel-like mixture into a foil and curing and/or compressing if appropriate; and
(c) laminating the resulting foil onto a carrier.

24. The process according to claim 22, which comprises providing the carrier component as a liquid, viscous, paste-like or gel-like material, providing the additive component as a bulk material, as a powder, as a liquid, viscous, paste-like or gel-like material, mixing the carrier component and the additive component together in an appropriate ratio by volume to form a mixture in the form of a liquid, viscous, paste-like or gel-like material and, optionally, carrying out a further processing step to prepare a foil as the material composition.

25. In combination with the material composition according to claim 1, a graphite-based, carbon-based, graphite-reinforced, or carbon-reinforced body or workpiece having the material composition according to claim 1 as oxidation protection.

26. The combination according to claim 25, wherein said material composition is provided as a coating on a surface of the body or workpiece or as a material admixture on or in the surface of the body or the workpiece.

27. The combination according to claim 25, wherein said body or said workpiece is a heat shielding element, a thermal tile, an electrode, an arc electrode, or a tool.

28. The combination according to claim 25, wherein said body is a seal between two workpieces.

29. The combination according to claim 28, wherein said body is a seal on a flange, a flat seal, a ring seal, or a band seal.
